(19) United States
(12) Patent Application Publication
(10) Pub. No.: US 2004/0022429 A1
(43) Pub. Date: Feb. 5, 2004

(54) Scanning microscope and inspection method employing the scanning microscope

(76) Inventors: Hidekazu Suzuki, Chiba-shi (JP); Atsushi Uemoto, Chiba-shi (JP)

Correspondence Address: ADAMS & WILKS, 31st Floor, 50 Broadway, New York, NY, 10004, US

(21) Appl. No.: 10/412,441

(22) Filed: Apr. 11, 2003

(30) Foreign Application Priority Data
Apr. 12, 2002 (JP) 2002-110878

(51) Int. Cl. G06K 9/00

(52) U.S. Cl. 382/145

(57) ABSTRACT

The scanning microscope system of the present invention, defect position information based on checking of the defect checking device for a plurality of defects in a chip, reference images corresponding to the defects in a neighboring chip are sequentially acquired, and then the field of view of the microscope is later moved to the defect areas on the defect chip. The defect position is extracted by comparing the reference image and the acquired defect image and acquisition of a high magnification defect image in the defect position is sequentially acquired for each defect.

### BACKGROUND OF THE INVENTION

1. Field of the Invention

The present invention relates to a scanning microscope such as a scanning electron microscope etc., and to semiconductor wafer defect checking technology employing this scanning microscope.

2. Description of Related Art

Inspections are implemented using defect checking devices to detect defects such as the adhesion of foreign matter that are the main cause of defective device operation as a means of managing yield in semiconductor device manufacturing processes. The defect checking devices detect defects and store the number and position of these defects in a defect file for subsequent devices. Semiconductor device wafers are manufactured by transferring a lattice of a large number of the same chips 2 onto a single wafer 1, as shown in FIG. 5. The checking, device then scans the surface of the wafer manufacture in this manner using an optical probe so as to detect defects. When a detect is detected, a chip number (for example, a way of showing which row of which column) specifying at which chip the defect exists and internal chip coordinate information specifying the position within the chip are stored in memory as a data file. Various monitoring and analysis of devices is carried out by microscopes and analysis apparatus based on this storage information and one of these is high resolution defect monitoring using an electron microscope for defect monitoring. With the defect monitoring electron microscope (hereinafter referred to as “precedent device”) developed by the present applicant, it is possible to observe SEM (Scanning Electron Microscope) images of arbitrary defects taken from the detected defects using a defect file for defects detected using the defect checking device. In order to observe arbitrary defects, first, a wafer map configuration (wafer map) measured by the defect-checking device is made. In order to make-a wafer map, information for an origin chip, chip size, and origin offset is required and this information is stored in a defect file. Next, alignment (coordinate alignment) of the coordinate systems for the wafer map and the precedent device is carried out. Next, the locations of defects within the defect file to be observed are moved to. The defect file is appended with the chip number and coordinates within the chip of the defect and it is therefore possible to logically and reliably move to these locations. However, in reality, the precision of the stages of the respective devices is the cause of errors and there are cases where a defect is not present within the line of vision of the SEM image when SEM observations are made at the moved to locations. In order to provide compatibility with such cases, it is necessary for the resolution with which SEM images are observed to be made low and the observation region broadened so that the defects are caught within the line of vision. A method is therefore provided where a person intervenes so that when a defect is to be observed at a high resolution, a defect is found from within the broadened observation region and the defect is moved (centering) to the center of the line of vision of the SEM image so that a high-resolution SEM image can be acquired. With the precedent device, the configuration is such that this operation is executed automatically. First, a low resolution SEM image is acquired by broadening the observation region to the chip having the target defect and the same location within the neighboring chip. FIG. -A shows a defect image and FIG. 1B shows a reference image for the same internal chip coordinates as for the defect. The defect is shown by numeral 3 in the drawings. In an efficient operation, first, a defect image is taken. Next, the defect location is moved to, and a low resolution SEM image (defect image) is acquired. Where the defect 3 is in the low-resolution SEM image acquired using the defect location is then detected from a difference image for the defect image and the reference image. The difference image is shown in FIG. 1C. Next, centering is carried out to the position detected within the defect image and a high-resolution image is automatically acquired as shown in FIG. 1D. After acquisition, the reference image acquisition operation for the next defect is proceeded to and a procedure is adopted where the same operation is then executed sequentially for respective defects three defects, A, B and C exist at chip number (i, j) as shown in FIG. 2 according to the checking information from the defect-checking device. In this case, the operating procedure of the precedent device carries out the aforementioned procedure on the defects A, B and C. Namely, as shown in the flowchart in FIG. 6, the following steps are carried out. Position information for detect A is acquired (step 1). A broadened observation region I is then extrapolated as coordinates on the chip in order to obtain a low resolution image centered on this position information (step 2). The field of view of the microscope is then set to a region I′ at a chip (i, j+1) neighboring the detect chip having the same coordinates as the observation region I and a reference image is acquired (step S3). Next, a defect image is acquired for the observation region I of the defect chip (step 4). Pattern matching is then carried out on the defect image acquired at this stage and the reference image and difference image for the matching portion is acquired (step 5). A detect image is then extracted from this image, centering is carried out, and a high-resolution image taking the position of this defect as center is automatically acquired (step 6). The operation of acquiring an observation image for one defect is then complete and the process is then executed again from step 1 for defect B. Therefore, in the example of the precedent device, the process from step 1 to step 6 is repeated three times, and it is necessary during this time to move the sample stage and take reference images for between the chip (i, j+1) neighboring the defect chip and the defect chip (i, j+1) 2×3=6 times. Movement between chips with a high-resolution electron microscope is relatively substantial movement and together with position alignment this takes some degree of time. This time is, however, multiplied in the process of checking a large number of defects oft a wafer so as to become quite a substantial amount of time.

The object of the present invention is, in an electron microscope equipped with a function for acquiring a high-magnification defect observation image by taking a reference image, comparing this with a defect image and then automatically extracting an accurate defect image, to reduce the number of times there is movement between chips and thereby reduce the checking time.

### SUMMARY OF THE INVENTION

With the electron microscope system of the present invention, for defect position information based on checking of the defect checking device, when a plurality of defects exist within the same chip, reference images corresponding to defects for neighboring chips are sequentially acquired so that when the field of view of the microscope is later moved on the defect chip, the defect position is extracted by comparing an acquired defect image, the defect image, and the reference image and acquisition of a high magnification defect image is sequentially acquired for each defect.

### BRIEF DESCRIPTION OF THE DRAWINGS

FIG. 1 is a view illustrating a method for extracting defect positions, performing centering, and then acquiring high-resolution defect images.

FIG. 2 is a view showing corresponding points on neighboring chips for acquiring defect chips and reference images.

FIG. 3 is a flowchart showing the operation of the microscope of the present invention.

FIG. 4 is a view showing the movement of points of a microscope occurring in a first embodiment of the present invention.

FIG. 5 is a view showing a semiconductor wafer arrayed with a multiplicity of chips to be subjected to checking.

FIG. 6 is a flowchart showing the operation of the microscope of the precedent technology.

FIG. 7 is a scanning microscope of the present invention.

### DETAILED DESCRIPTION OF THE PREFERRED EMBODIMENTS

The object of the present invention is, in an electron microscope equipped with a function for automatically acquiring a high-magnification defect observation image by taking a reference image, comparing this with a defect image and then automatically extracting an accurate defect image, the aim is to reduce checking time by reducing the number of times there is movement of the optical system between chips.

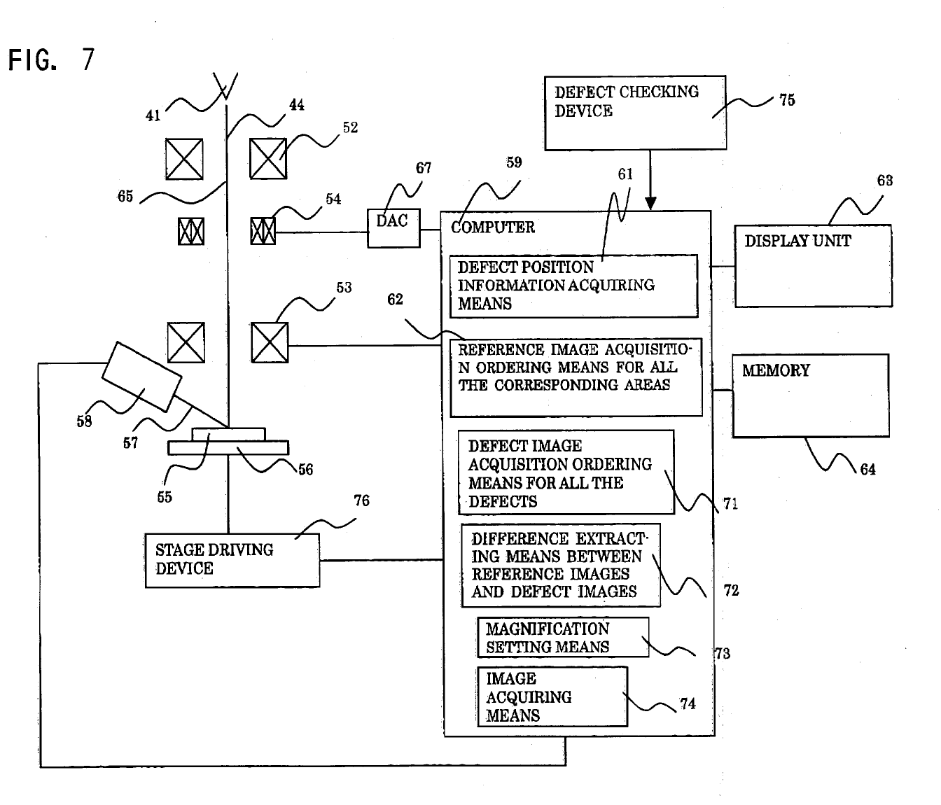

A description of the scanning microscope of the present invention will be given referring to FIG. 7.

In advance defect checking device 75 checks detect positions of foreign matters adhered to the sample. Defect checking device 75 comprises a relatively low magnification microscope; The defect-checking device identifies chips having defections and the defect positions in the chips. The scanning microscope of the present invention acquires information of the defect positions from the defect-checking device 75. Next, the sample 55 is displaced on the sample stage 56. The-magnification setting means sets the microscope to a low magnification, which is done by changing current intensities of deflector 54 and changing scanning width of beam 65 on the sample. The following operations are done by “reference image acquisition ordering means for all the corresponding areas” 71.

1) Moving the stage 66 via stage driving device 76 so as to obtain images of the chip neighboring the chip having detects.

2) Operating deflector 54 via DAC 67 based on the order from reference image acquisition-ordering means 62. Beam 65 from beam source 41 is focused on the sample 55 by objective lens 53 after condensed by condenser lens 52 and deflected by deflector 54. Thus beam 65 scans the area corresponding to the first defect area. At this time, secondary electrons 57 generates from the sample 55. The secondary electron detector 58 detects the generated secondary electrons. Image acquiring means 74 obtains reference images based on signals from the secondary electron detector 58. The information obtained by the image acquiring means 74 is displayed on the display unit 63. The second area corresponding to the second defect area is brought to the observation position by moving the stage 56. And in the same way the reference image of the area corresponding to the second defect area is obtained. Hereafter the image acquiring means 74 sequentially obtains reference images of the areas of the neighboring chip corresponding to the defect areas of the chip having defects.

Thus, in the chip neighboring the chip having defects the reference images of the areas corresponding to areas where defects exists for all the defects.

That is, when a plurality of defects exist, the reference image acquisition ordering means 62 orders to obtain the reference images in the neighboring chip for all the areas corresponding to the areas where the plurality of defects exists.

After obtaining all the reference images, the following operations are done by the order from “the defect image acquisition ordering means for all the defects” 71

1) Moving the stage 56 via the stage-driving device 76. The movement brings the first defect position of the chip having the defects to the observing position of the-microscope.

2) Obtaining the image of the first detect area

3) Obtaining the image of each defect area one after another for all the defect areas

The next operations a), b), c) are done after obtaining all the reference images and all the defect area images.

a) Difference extracting means 72 extracts the difference between reference images and defect images, that is, extracts the image of the first defect itself.

b) Image acquiring means 74 obtains a high magnification image of the extracted image of the first defect. Namely, stage-driving device 76 moves the stage 56 in the manner that the position of the extracted image of the first defect comes to the center of the view. The magnification setting means 73 Sets the microscope to a high magnification thus the image acquiring means 71 obtains a high magnification defect image for the first defect.

c) The microscope repeats the operation of a), b) for all the other defects, and obtains high magnification defect images for all the other defects.

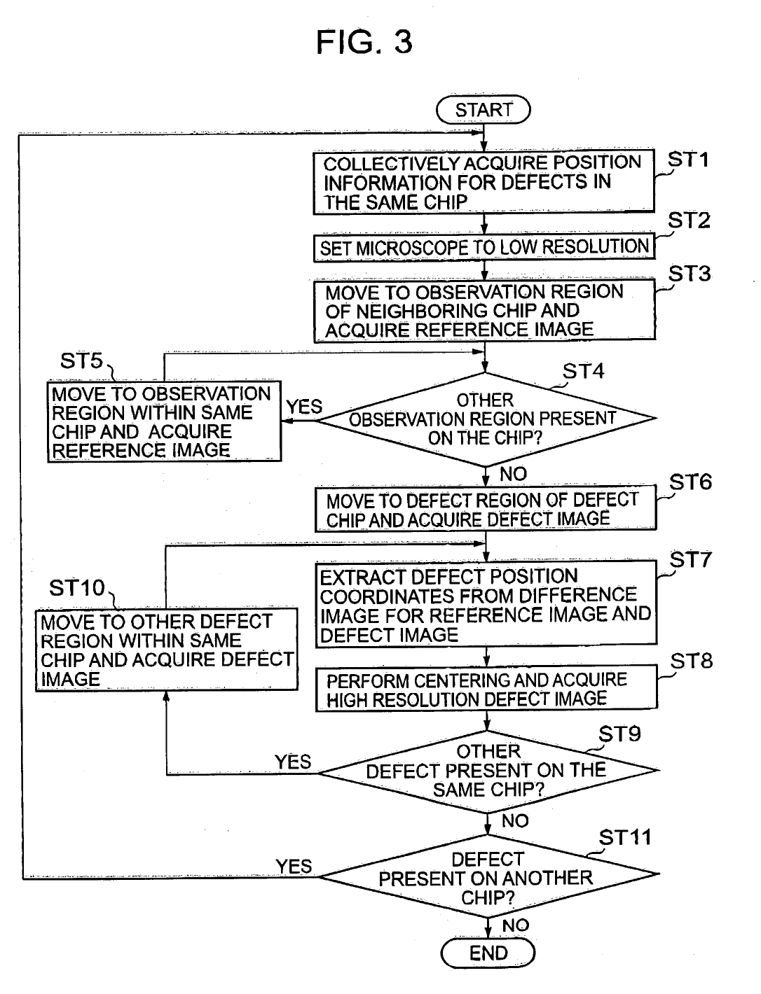

A description will now be given with reference to FIG. 3 of the flow of the operation of the present invention. In step 1, defect position information is collectively acquired for every chip number from checking data from the defect-checking device. This position information is position information obtained for the coordinate system for the defect checking device, i.e. is constituted by a chip number and coordinate information for within the chip specifying the position within the chip. When this information employs a microscope coordinate system, then there will not be complete coincidence with the defect position. This is because there are relative errors typified by drift errors between the coordinate systems. The aforementioned errors are likely when processing proceeds using the microscope coordinate systems and a low-resolution image is therefore initially acquired so that a defect does not become removed from the field of view of the microscope. The resolution of the microscope is therefore set low in step 2 of the present invention. In order to accurately catch the defect positions in the microscope coordinate system, difference information is processed for the defect image and the reference image as described for the precedent device and an defect image is extracted. It is being taken that a reference image is obtained for the neighboring chip, but this is not to assume that the neighboring chip is a perfect chip that does not have defects. It is sufficiently likely that the neighboring chip will have a defect. However, assuming that the main defects in the check are likely to be foreign bodies that have become attached, it is unlikely that foreign bodies will have become attached to the same position on the neighboring chip and use as a reference image therefore presents no problem. In step 3 for acquiring this reference image, the microscope first acquires a reference image before the defect image. This is because it is then possible to obtain the final necessary high-resolution detect image without having to move between chips again. The most significant feature of the present invention is to have as small an amount of movement between chips as possible. Namely, in step 4, a determination is made as to whether or not a plurality of defects exists on the noted chip. When this is the case, step 5 is proceeded to, the microscope is moved to the coordinate position corresponding to another defect, and a reference image is acquired. This is repeated for all of the defects but it is significant that all of the movement at this time is between neighboring chips.

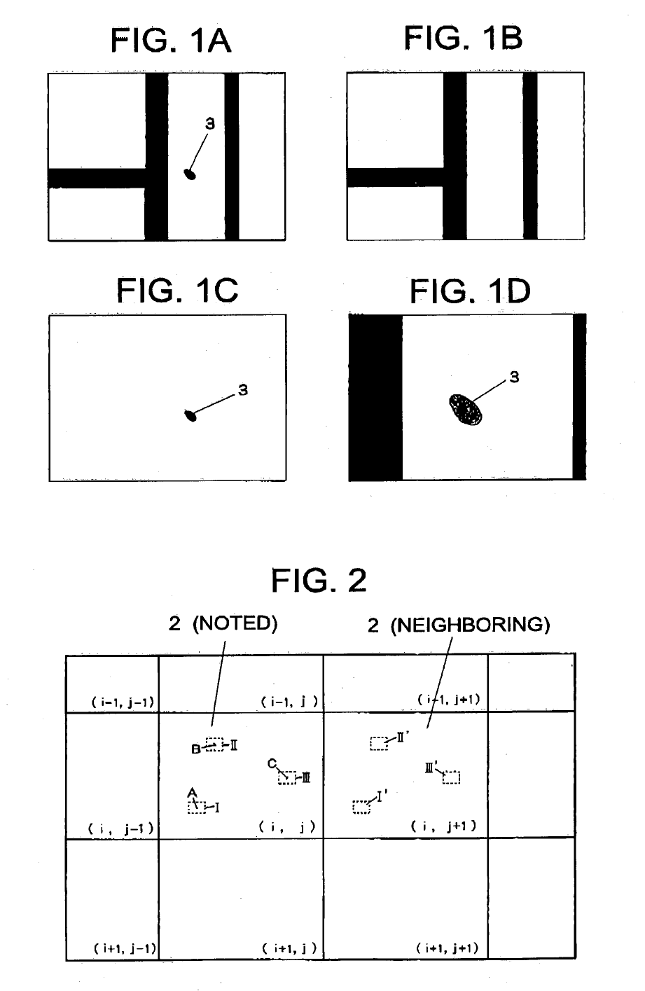

It is then confirmed that reference images have been acquired for all of the defects and step 6 is proceeded to. The microscope is then moved to the position of the defect on the noted chip and a defect image is acquired. The position information used during this tine is position information acquired using the defect checking device but the microscope image is kept to a low resolution so that the defect is reliably caught within the field of vision of the microscope, FIG. 1A and FIG. 1B correspond to the defect image and the reference image during this time. Next, step 7 is proceeded to, pattern matching is carried out for this defect image and reference image, difference operations are performed on the corresponding pixel information, and portions for the same pattern are cancelled out. An image of different portions, i.e. the defect image shown in FIG. 1C is then extracted as a result of this signal processing. This defect image is captured from the microscope image and its position is therefore position information in the microscope coordinate system. To proceed, the microscope is then centered on the defect position obtained in step 8, the microscope is set to a high resolution and a high-resolution defect image is obtained. In step 9, confirmation is made as to whether or not there is another defect on the same chip. When this is the case, step 10 is proceeded to and the resolution of the microscope is set to be low. In step 11, the microscope is moved to another defect position and a defect image is acquired. Movement at this time is a short distance within the same chip. After the defect image is acquired, step 7 is returned to, difference information is obtained, and a defect position is captured. Centering is then carried out and a high-resolution defect image is obtained in the same manner as in the case of the previous defect. At the stage where all of the defect images have been acquired, when the determination in step 9 brings the response of “no”, step 12 is proceeded to. In cases where the presence or absence of defects for which images are not acquired at other chips is confirmed so that there are defects at other chips for which a high-resolution image has not yet been acquired, step 1 is returned to and the same operation is carried out for defects of the chips. This operation is then ended when images have been acquired for all of the chip defects on the wafer.

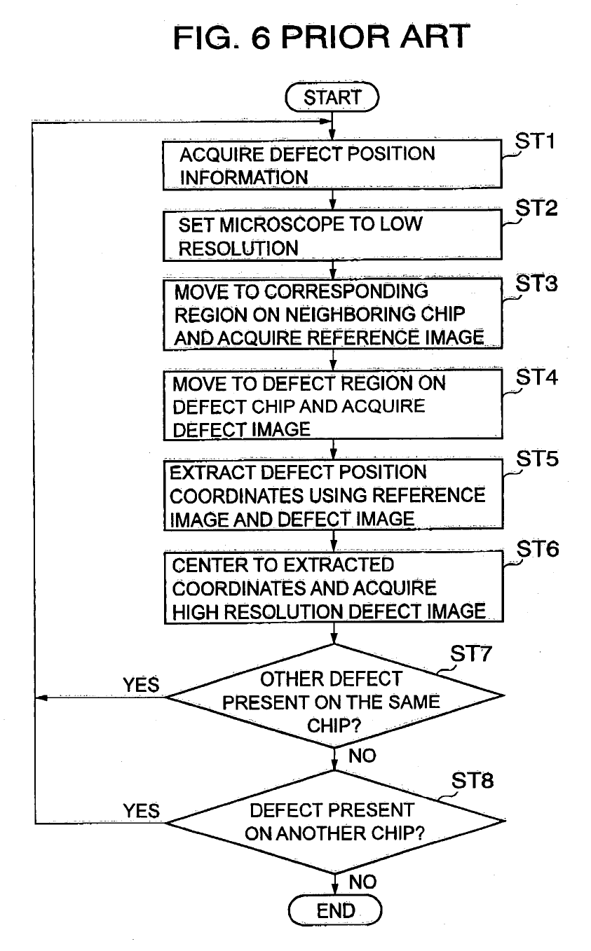

In the operation for the present invention above, when it is taken that there are n defects on one chip, substantial movement in excess of, that between neighboring chips occurs one time in step 3, one time in step 6, with movement between neighboring chips then taking place n−1 times in step 5, and movement within defect chips taking place n−1 times in step 11. The total number of times of movement of the sample therefore becomes 1+1+n−1+n−1=2n. In the precedent device shown in FIG. 6, movement between chips takes place two times in step 3 and step 4 for one defect, and this is repeated n times, giving the number of times of movement as 2n, which is the same as in this case. It is necessary for this type of microscope acquiring high-resolution images of defects based on defect position information from a defect-checking device to acquire a low-resolution reference image, a low-resolution defect image and a high-resolution defect image for each defect. However, although the number of movements of the sample is the same in each case, whereas the flow of the precedent device is such that all of the movement is substantial movement between chips, the flow in the present invention is such that movement between chips only takes place two times in step 3 and step 6, with the other (n−1) movements in step S and (n−1) movements in step 11 all being small amounts of movement within chips. There are also cases where the same image is acquired and the same image processing is carried out, but operation time can also be made shorter by avoiding reciprocal movement of the microscope between chips operations for each chip are carried out on all of the defect chips. Differences in the time taken for these cumulative operations are therefore large and become larger for larger chip sizes.

In the above description, checking of the chips arrayed on the semiconductor wafer for defects is carried out using a scanning electron microscope. However, the reference image pre-reading function of the present invention is by no means limited in this respect and the present invention may also be applied to other scanning microscopes such as ion microscopes and probe microscopes etc.

Embodiments

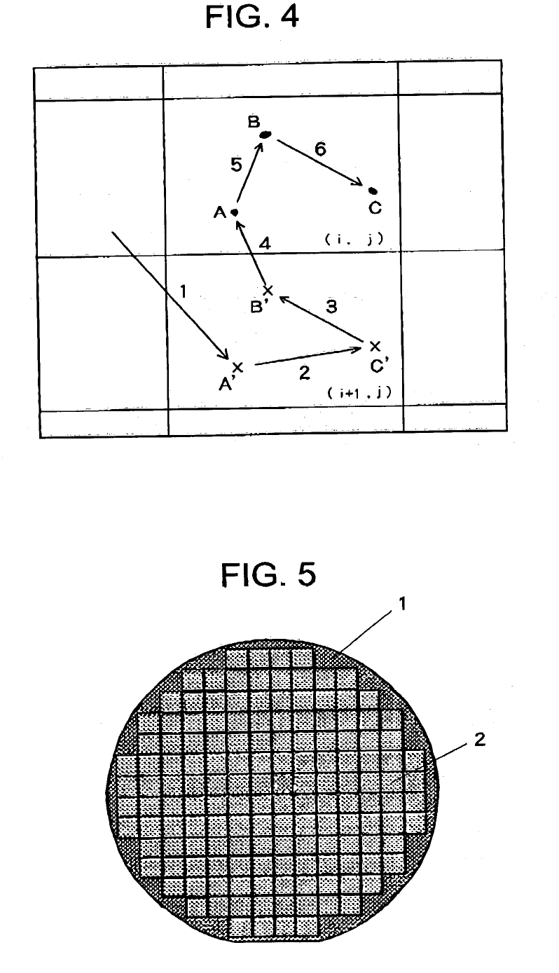

A specific moving point deciding method for implementing the present invention is described in the following. It is taken that there are three defects on the noted chip of A, B and C, as shown in FIG. 4. There are four neighboring chips that are candidates for acquiring reference images. If the shapes of the chips are square shapes where the horizontal and vertical dimensions are the same, then theoretically the same conditions will apply whichever chips are selected. However, in the case where the horizontal dimensions are longer as shown in FIG. 4, upper and lower chips of chip numbers (i−1, j) and (i+1, j) are selected. This is because with this chip array the distance to move is less because the space between columns is less than the space between rows. In this example, chip number (i+1, j) is selected and acquisition of the reference images takes place in order from the furthest position from the defect chip to sequentially closer positions. Namely, in the initial step 3, point A′ of the chip is accessed (arrow 1 in FIG. 4). Then, in step 5, the point Ca′ is first moved to (arrow 2 in FIG. 4) and point B′ is then moved to (arrow 3 in PIG. 4) this is to take into consideration that little movement is required to the defect chip in step 6 executed next. Here, selection is such that a reference image is obtained for a chip from the neighboring column and is decided using the vertical coordinate value.

Movement of the point to the defect Chip in step 6 is taken to be to defect A (arrow 4 in FIG. 4) and this is because the vertical coordinate value is the closest for the neighboring chip. Continuing on, movement of the point within the defect chip in step 11 is taken to be from the point (defect A in this case) in step 6 to the nearest defect (defect B in this case: arrow 5 in FIG. 4), with values for the closest points (defect C in this case: arrow 6 in FIG. 4) then being selected sequentially from then on this is considered as movement Only within the same chip and the distance moved is therefore short.

The movement of the point of the microscope due to the method of this embodiment is therefore from A′ to C′ to B′ to A to B to C, as shown in FIG. 4.

In a function for pre-reading a reference image for a scanning microscope of the present invention, a low magnification defect image and a reference image corresponding to the same region are acquired based on defect position information from a defect checking device, a defect position is extracted from difference information for both images, and centering takes place to this position so that a high magnification image is obtained for the defect. Therefore, when a plurality of defects exist on the same chip, first, reference images corresponding to all of the defects of chips neighboring the chip are sequentially acquired, and the reference image is then pre-read. The amount of movement of the microscope is therefore small and the checking of chips arrayed on a semiconductor wafer can be achieved in a short period of time.

Acquisition of the reference images takes place in order from the furthest position from the defect chip to sequentially closer positions. Movement of the microscope can therefore be rationalized still further and the checking of chips arrayed on the semiconductor wafer can be implemented in a short period of time.

1. A method for inspecting chips arrayed on a semiconductor wafer using a scanning microscope where low magnification defect images and reference images corresponding to the same position regions of each chip are acquired based on defect position information from a defect checking device, a defect position is extracted from difference information for both images, and centering takes place to this position so that a high magnification image is obtained for the defect, wherein for a plurality of defects which exist within the same chip, reference images corresponding to all of the defects of chips neighboring the chip are sequentially acquired to be pre-read at first.

2. The method for checking chips arrayed on a semiconductor water according to claim 1, wherein after the reference images are acquired the method further comprising the steps of:
moving the field of vision of the microscope to the defect chip,
sequentially acquiring defect images of the defect chip;
extracting defect images by comparing the defect images and the reference images; and
bringing each defect position to the center of the view field and acquiring each defect image with a high resolution.

3. The method for checking chips arrayed on a semiconductor wafer according to claim 1, wherein acquisition of the reference images takes place in order from the furthest position from the defect chip to sequentially closer positions.

4. The method for checking chips arrayed on a semiconductor wafer according to claim 2, wherein acquisition of the reference images takes place in order from the furthest position from the defect chip to sequentially closer positions.

5. A scanning microscope comprising:
means for acquiring defect position information every chip from defect information of a defect checking device;
means for ordering acquisition of reference images for all the areas on the neighboring chip of a defect chip, each area having the same coordinate point as that of the defect position of the defect chip;
means for acquiring low-resolution reference images for each of all the areas on the neighboring chip based on the order from means for ordering acquisition of reference images;
means for ordering acquisition of defect area images for all the areas on the defect chip, each area having a defect;
means for acquiring a low-resolution image of the defect area for each of all the areas on the defect chip based on the order from means for ordering acquisition of defect area images;
means for extracting the difference between a defect area image and a corresponding reference image for each of all the defect areas to obtain a coordinate of each defect; and
means for bringing the center of the observation field to the coordinate of each defect and acquiring a high resolution defect image for each defect.
